(19) United States
(12) Patent Application Publication
(10) Pub. No.: US 2021/0134481 A1
(43) Pub. Date: May 6, 2021

(54) CABLE JACKETS WITH MAGNETIC ATTRACTION

(71) Applicant: CommScope Technologies LLC, Hickory, NC (US)

(72) Inventor: Mark O. VOGEL, Statesville, NC (US)

(21) Appl. No.: 17/060,063

(22) Filed: Sep. 30, 2020

Related U.S. Application Data
(60) Provisional application No. 62/928,723, filed on Oct. 31, 2019.

(51) Int. Cl. H01B 7/00; G02B 6/44; H01B 9/00

(52) U.S. Cl. CPC H01B 7/009; H01B 9/005; G02B 6/4434

(57) ABSTRACT

A cable includes a communication carrying medium or a conductive medium. A jacket surrounds the medium along the length of the cable. At least one magnet is embedded within, attached to an outer surface of, or abutting an inner surface of, the jacket. The at least one magnet allows one cable to be attached to another cable, even if only temporarily, so that plural cables can be installed as a single unit. Magnetic attraction may exist as a jacket-to-jacket attraction between first and second cables. Alternatively, magnetic attraction may be used to attach a first cable to an intermediary, such as a spine, and also used to attach a second cable to the same intermediary.

This application claims the benefit of U.S. Provisional Application Ser. No. 62/928,723, filed Oct. 31, 2019, which is herein incorporated by reference.

### BACKGROUND OF THE INVENTION

### 1. Field of the Invention

The present invention relates to cables, which may include one or more communication mediums and/or one or more power supplying mediums. More particularly, the present invention relates to a cable with magnetic attraction, such that the cable can be temporarily attached to another cable or object by a magnetic attraction.

### 2. Description of the Related Art

Electronic devices for facilitating data, video and/or voice communications are often located in outside environments. For example, cellular systems, wifi systems, security systems and/or other networked devices are often mounted to power poles, street lights, buildings and/or cell towers. Such devices need to have access to both a power source and a central communications server. Many electronic devices use optical fibers or twisted pairs to transmit and receive communication signals with the central communications server.

When connecting power and communication channels to the electronic device, it is often required that the cabling extend up towers, poles, building walls, etc. Many operators are installing one or more communication cables up to the electronic device and also installing one or more power cables up to the same electronic device. Installation costs and tower rent agreements are often based upon a per-cable charge or a per-foot of cable charge. Therefore, the use of a hybrid cable, which possesses both power conductors, twisted pairs, coaxial conductors and/or optical fibers is known and desired in the art to reduce the installation costs, and any rent cost once the cable is installed. Similar per-foot and/or per-cable charges are common with the underground installation of cables, e.g., cables used in a direct burial or within an underground conduit.

### SUMMARY OF THE INVENTION

The Applicant has appreciated that sometimes a hybrid cable is not a cost effective solution to reduce the per-foot installation and/or rental fees. For example, tower-mounted equipment varies greatly dependent upon manufacturer and capacity. If a given installation requires three fourteen gauge power wires, twenty four optical fibers and two twisted pairs of conductors, it is possible that such an exact hybrid cable does not exist. A first option would be to pay a cable manufacturer to produce the exact hybrid cable desired. The costs for such a custom cable would be high on a per-foot basis if only a few thousand feet of the cable were needed. A second option would be to install a hybrid cable with excess capacity, such as a hybrid cable with three twelve gauge power lines, forty eight optical fibers and four twisted pairs of conductors. The extra capacity, e.g., larger power conductors, unused fibers and unused twisted pairs of conductors, would represent added costs to the overall project which serve no immediate purpose.

The Applicant has appreciated that each of the component parts of the hybrid cable currently exist individually as common cables. For example, a power cable with three fourteen gauge conductors exists in the market. Also, a fiber optic cable with twenty four optical fibers and a cable with only two twisted pairs of the conductors are known to exist in the market. The Applicant has created a structure which will allow the common cables to be attached, even if only temporarily, so that plural cables can be installed as a single unit.

Magnetic attraction is used to attach a first cable to a second cable. Alternatively, magnetic attraction is used to attach a first cable to an intermediary, such as a spine, and also used to attach a second cable to the same intermediary. In various embodiments, the magnet may be embedded within, or attached to an outer surface of, or abutting an inner surface of, the jacket.

The Applicant has appreciated that each of the different elements within a hybrid cable are typically routed to separate optical/electronic units. For example, the power conductors may be routed to a power supply unit, the optical fibers may be routed to electro/optical converter or amplifier units, and the twisted pairs may be routed to control units. Each of these units typically includes its own dedicated modular housing. Since the hybrid cable has only a single outer jacket the jacket will be removed at some distance from each of the housings. The inner elements of the hybrid cable will be routed to the appropriate housings and may have exposure to the environment before entering the housings. Often additional materials, e.g., heat shrink wrap, will be applied thereto. With the present invention, the different element types will each have a separate outer jacket. For example, the outer jacket surrounding the twisted pairs can be routed through a weatherproof grommet in a wall of the control unit housing, and there would be no need for the extra material or steps to seal the twisted pairs from the environment between the opening in the hybrid cable jacket to the entrance in the wall of the control unit housing.

These and other objects are achieved by a cable comprising a conductive medium extending along a length of said cable; a jacket surrounding said conductive medium along the length of said cable; and a magnet embedded within, attached to an outer surface of, or abutting an inner surface of, said jacket.

Further, these and other objects are achieved by a cable comprising a communication carrying medium extending along a length of said cable; a jacket surrounding said communication carrying medium along the length of said cable; and a magnet embedded within, attached to an outer surface of, or abutting an inner surface of, said jacket.

Moreover, these and other objects are achieved by a method of forming a cable comprising: providing an extruder and a die; adding polymer pellets to the extruder; feeding a conductive or communication carrying medium to the die; melting the polymer pellets; extruding the melted polymer pellets to form a jacket over the medium using the die; and positioning at least one magnet into the extruded jacket, so as to embed the at least one magnet within the jacket.

Furthermore, these and other objects are achieved by a method of forming a cable comprising: providing an extruder and a die; adding polymer pellets to the extruder; feeding a conductive or communication carrying medium to the die; feeding at least one magnet to the die; melting the polymer pellets; and extruding the melted polymer pellets to form a jacket over the medium and the at least one magnet using the die.

Finally, these and other objects are achieved by a method of forming a cable comprising: providing an extruder and a die; adding polymer pellets to the extruder; feeding a conductive or communication carrying medium to the die; melting the polymer pellets; extruding the melted polymer pellets to form a jacket over the medium using the die; and attaching at least one magnet onto an outer surface of the jacket.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front perspective view of a twisted pair cable in accordance with a first embodiment of the present invention;

FIG. 2 is a cross sectional view taken along line II-II in FIG. 1;

FIG. 3 is a diagram depicting cable-to-spine magnetic attraction to removably connect three cables together;

FIG. 4 is a diagram depicting cable-to-spine magnetic attraction to removably connect six cables together;

FIG. 5 is a diagram depicting cable-to-cable magnetic attraction to removably connect three cables together;

FIG. 6 is a diagram depicting cable-to-cable magnetic attraction to removably connect nine cables together;

FIG. 7 is a close-up view of a section of a jacket illustrating a magnet abutting, e.g., attached to, an inner surface of the jacket;

FIG. 8 is a close-up view of a section of a jacket illustrating a magnet attached to an outer surface of the jacket;

FIG. 9 is a cross sectional view of a power cable in accordance with a second embodiment of the present invention;

FIG. 10 is a front perspective view of a coaxial cable in accordance with a third embodiment of the present invention;

FIG. 11 is a cross sectional view taken along line XI-XI in FIG. 10;

FIG. 12 is a front perspective view of a fiber optic cable in accordance with a fourth embodiment of the present invention; and

FIG. 13 is a cross sectional view taken along line XIII-XIII in FIG. 12.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

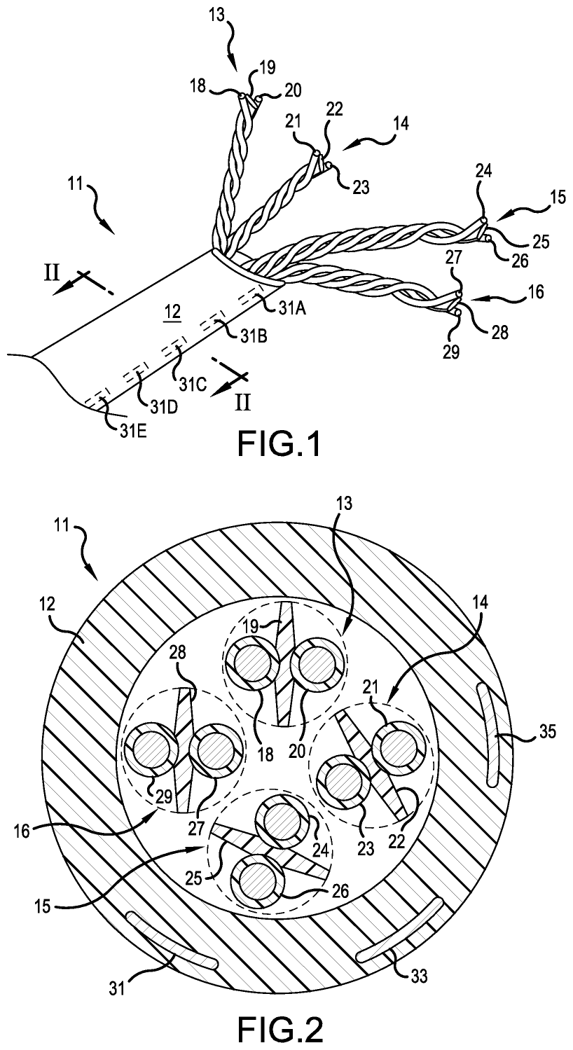

FIG. 1 is a front perspective view of a cable 11 in accordance with a first embodiment of the present invention. FIG. 2 is a cross sectional view taken along line II-II in FIG. 1. A communication carrying medium, such as a conductive medium, extends along a length of the cable 11. In the embodiment of the FIGS. 1 and 2, the conductive medium includes twisted pairs of insulated conductors, such that the cable 11 is a twisted pair cable 11. More particularly, the twisted pair cable 11 includes a jacket 12 formed around and surrounding first, second, third and fourth twisted pairs 13, 14, 15 and 16, along the length of the twisted pair cable 11. FIGS. 1 and 2 do not illustrate a pair separator. However, pair separators (sometimes referred to as tapes, isolators, flutes or crosswebs) may optionally be included, if desired.

As best seen in the cross sectional view of FIG. 2, the first twisted pair 13 includes a first insulated conductor 18, a first dielectric tape 19, and a second insulated conductor 20. The first insulated conductor 18 is twisted with the second insulated conductor 20, in a helical fashion, with the first dielectric tape 19 residing between the first insulated conductor 18 and the second insulated conductor 20.

The second twisted pair 14 includes a third insulated conductor 21, a second dielectric tape 22, and a fourth insulated conductor 23. The third insulated conductor 21 is twisted with the fourth insulated conductor 23, in a helical fashion, with the second dielectric tape 22 residing between the third insulated conductor 21 and the fourth insulated conductor 23.

The third twisted pair 15 includes a fifth insulated conductor 24, a third dielectric tape 25, and a sixth insulated conductor 26. The fifth insulated conductor 24 is twisted with the sixth insulated conductor 26, in a helical fashion, with the third dielectric tape 25 residing between the fifth insulated conductor 24 and the sixth insulated conductor 26.

The fourth twisted pair 16 includes a seventh insulated conductor 27, a fourth dielectric tape 28, and an eighth insulated conductor 29. The seventh insulated conductor 27 is twisted with the eighth insulated conductor 29, in a helical fashion, with the fourth dielectric tape 28 residing between the seventh insulated conductor 27 and the eighth insulated conductor 29.

The jacket 12 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art. Of particular relevance to the present invention, first, second and third magnets 31, 33 and 35 are embedded within the jacket 12. The first, second and third magnets 31, 33 and 35 may be formed as ferrous magnets, but are more preferably formed as rare-earth magnets, such as an alloy of neodymium, iron and boron neodymium, e.g., neodymium magnets. A neodymium magnet can offer five to ten times the attraction strength as compared to a ferrous magnet.

The first, second and third magnets 31, 33 and 35 may be embedded into the jacket 12 as the jacket 12 is being extruded onto the cable core, e.g., the first, second, third and fourth twisted pairs 13, 14, 15 and 16. As the extruded jacket 12 is cooled in a water bath, the jacket 12 will solidify around the first, second and third magnets 31, 33 and 35 to capture the magnets within the material forming the jacket 12. The first, second and third magnets 31, 33 and 35 may be positioned in first, second and third positions along the jacket 12.

In one embodiment, the first, second and third magnets 31, 33 and 35 are spaced from each other in a radial direction around a perimeter the jacket 12, and each of the first, second and third magnets 31, 33 and 35 extends continuously along the length of the twisted pair cable 11. In the embodiment depicted in FIG. 2, the second position of the second magnet 33 is located less than ninety degrees away from the first position of the first magnet 31 around the perimeter of the jacket 12. Also, the third position of the third magnet 35 is located less than ninety degrees away from the second position of the second magnet 33 around the perimeter of the jacket 12.

In an alternative or supplemental embodiment, each of the first, second and third magnets 31, 33 and 35 does not extend continuously, but rather is a series of shorter magnets, where the series extends along the length of the twisted pair cable 11, as illustrated by the dashed line segments 31A, 31B, 31C, 31D and 31E of the first magnet 31 in FIG. 1. In other words, a second portion 31B of the first magnet 31 is spaced from a first portion 31A of the first magnet 31 along the length of the cable 11. A third portion 31C of the first magnet 31 is spaced from the second portion 31B of the first magnet 31 along the length of the cable 11, and so forth. Plural additional portions 31C, 31D, 31E, . . . are spaced along the length of the cable 11 so as to form, in conjunction with the first, second and third portions 31A, 31B and 31C, a series of spaced magnets extending linearly along the length of the cable 11.

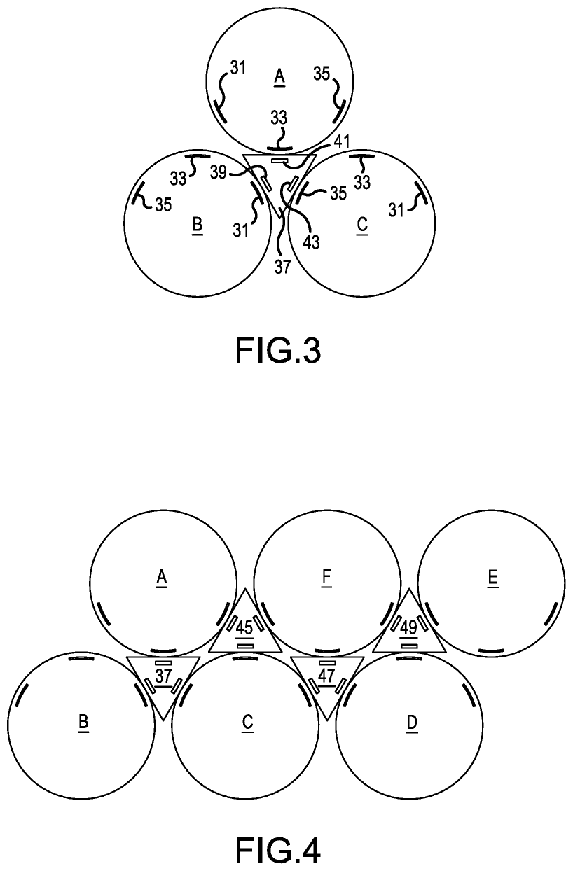

FIG. 3 illustrates how three cables A, B and C may be linked together using the first, second and third magnets 31, 33 and 35. The cables A, B and C may each be a twisted pair cable, as shown in FIGS. 1 and 2. However, as will be described in later embodiments, the three cables A, B and C may be of different types.

In FIG. 3, a first spine 37 includes fifth, sixth and seventh magnets 39, 41 and 43. The first magnet 31 of cable B is magnetically attached to the fifth magnet 39 of the first spine 37. The second magnet 33 of cable A is magnetically attached to the sixth magnet 41 of the first spine 37. The third magnet 35 of cable C is magnetically attached to the sixth magnet 43 of the first spine 37. By the arrangement of FIG. 3, three cables A, B and C may be installed as a single unit, e.g., up a tower or by direct burial. Yet, the three cables A, B and C may be easily separated at an end destination by simply pulling the jackets apart and terminating the three cables A, B and C in a conventional fashion within respective modules or housings as needed.

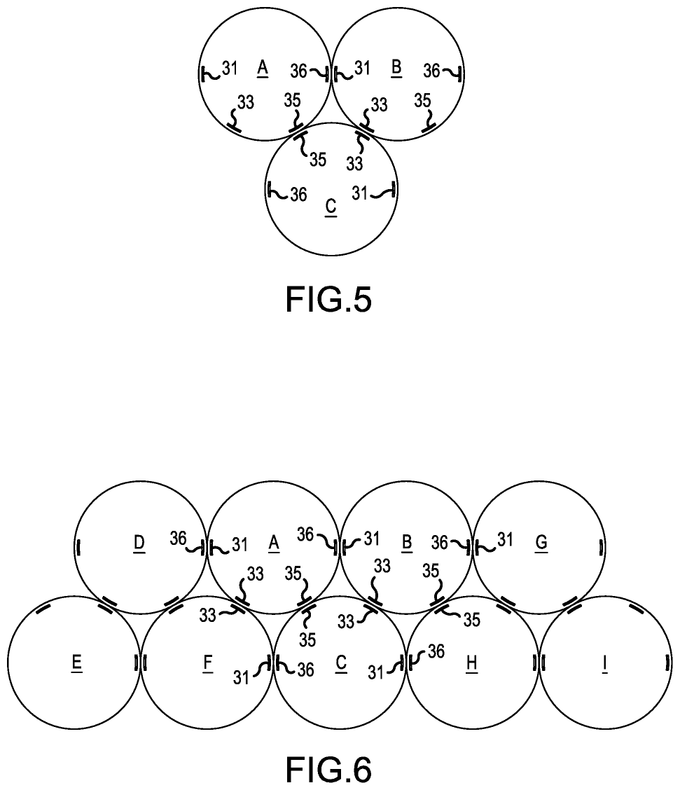

FIG. 4 illustrates how the jackets of six cables A, B, C, D, E and F may be interconnected using magnetic attractions. The embodiment of FIG. 4 includes four spines, namely the first spine 37 as well as second, third and fourth spines 45, 47, and 49, respectively. Again, the cables A, B, C, D, E and F may each be a twisted pair cable, as shown in FIGS. 1 and 2. However in preferred embodiments, as will be described in later embodiments, the cables A, B, C, D, E and F may be of different types.

FIG. 5 illustrates how three cables A, B and C may be linked together using first, second, third and fourth magnets 31, 33, 35 and 36. The cables A, B and C may each be a twisted pair cable, as shown in FIGS. 1 and 2, except for the addition of the fourth magnet 36. However, as will be described in later embodiments, the three cables A, B and C may be of different types.

In FIG. 5, no spine is needed. The fourth magnet 36 of cable A is magnetically attached to the first magnet 31 of the cable B. The third magnet 35 of cable A is magnetically attached to the third magnet 35 of the cable C. Finally, the second magnet 33 of cable C is magnetically attached to the second magnet 33 of the cable B. By the arrangement of FIG. 5, three cables A, B and C may be installed as a single unit, e.g., up a tower or by direct burial. Yet, the three cables A, B and C may be easily separated at an end destination by simply pulling the jackets apart and terminating the three cables A, B and C in a conventional fashion.

FIG. 6 illustrates how the jackets of nine cables A, B, C, D, E, F, G, H and I may be interconnected using magnetic attractions. Again, the cables A, B, C, D, E, F, G, H and I may each be a twisted pair cable, as shown in FIGS. 1 and 2. However in preferred embodiments, as will be described in later embodiments, the cables A, B, C, D, E, F, G, H and I may be of different types.

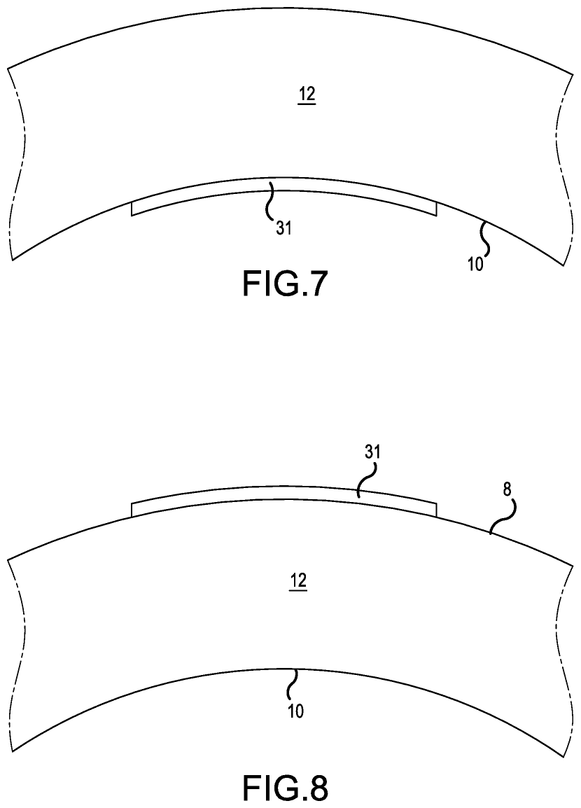

FIG. 2 illustrated that the first, second and third magnets 31, 33 and 35 were embedded within the material forming the jacket 12. FIG. 7 illustrates an embodiment wherein the first magnet 31 is abutting an inner surface 10 of the jacket 12. The second, third and/or fourth magnets 33, 35 and/or 36 may be similarly arranged. Abutment includes either an attachment to the inner surface 10 of the jacket 12 or a mere placement beside the inner surface 10 of the jacket 12 without an attachment. The first, second, third and/or fourth magnets 31, 33, 35 and/or 36 may be applied to the cable core, much like drain wires or rip cords, prior to the extrusion of the jacket 12 over the cable core.

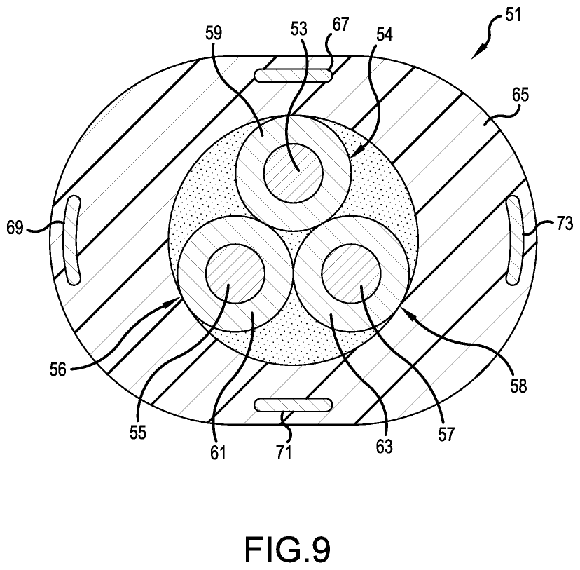

FIG. 8 illustrates an embodiment wherein the first magnet 31 is attached to an outer surface 8 of the jacket 12. The second, third and/or fourth magnets 33, 35 and/or 36 may be similarly arranged. The first, second, third and/or fourth magnets 31, 33, 35 and/or 36 may be applied to the outer surface 8 of the jacket, after the extruded jacket 12 has cooled. In a preferred embodiment, the first, second, third and/or fourth magnets 31, 33, 35 and/or 36 may be applied to the outer surface 8 of the jacket 12 proximate the production stage where the jacket 12 passes through the labeling machines, which print or etch data onto the outer surface 8 of the jacket 12 relating to length markers, production date, manufacturer, part number, etc. Also, the first, second, third and/or fourth magnets 31, 33, 35 and/or 36 may be applied by adhesive in the field by a technician just prior to installation of section of the cable up a pole/tower or within a conduit or prior to direct burial.

FIG. 9 is a cross sectional view of a cable 51 in accordance with a second embodiment of the present invention. At least one conductive medium extends along a length of the cable 51. In the embodiment of the FIG. 9, the at least one conductive medium includes first, second and third conductive mediums 53, 55 and 57. A first insulation layer 59 surrounds the first conductive medium 53 to form a first insulated wire 54. A second insulation layer 61 surrounds the second conductive medium 55 to form a second insulated wire 56. Also, a third insulation layer 63 surrounds the third conductive medium 57 to form a third insulated wire 58.

A jacket 65 surrounds the first, second and third insulated wires 54, 56 and 58 along the length of the cable 51, such that the cable 51 is a power conducting cable 51. Often times, the first, second and third insulated wires 54, 56 and 58 are referred to a hot, neutral and ground, or referred to as positive, negative and ground (or drain). Also, the ground (drain) wire is sometimes bare and does not include the third insulation layer 63.

The jacket 65 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art. Of particular relevance to the present invention, first, second, third and fourth magnets 67, 69, 71 and 73 are embedded within the jacket 65. The first, second, third and fourth magnets 67, 69, 71 and 73 may be formed as rare-earth magnets, such as an alloy of neodymium, iron and boron neodymium, e.g., neodymium magnets.

The first, second, third and fourth magnets 67, 69, 71 and 73 may be embedded into the jacket 65 as the jacket 65 is being extruded onto the cable core, e.g., the first, second and third insulated wires 54, 56 and 58. As the extruded jacket 65 is cooled in a water bath, the jacket 65 will solidify around the first, second, third and fourth magnets 67, 69, 71 and 73 to capture the magnets within the material forming the jacket 65.

As with the first embodiment, the first, second, third and fourth magnets 67, 69, 71 and 73 are spaced from each other in a radial direction, e.g., ninety degrees apart in FIG. 9, and each of the first, second, third and fourth magnets 67, 69, 71 and 73 extends continuously along the length of the twisted pair cable 11. Alternatively, each of the first, second, third and fourth magnets 67, 69, 71 and 73 does not extend continuously, but rather is a series of shorter magnets, where the series extends along the length of the power conducting cable 51, similar to the dashed line segments 31A, 31B, 31C, 31D and 31E illustrated in FIG. 1. The magnets will allow the power conducting cable 51 to be magnetically coupled to another power conducting cable 51 or to a twisted pair cable 11, either by direct jacket-to-jacket coupling, or via an intermediate spine.

Although four magnets 67, 69, 71 and 73 are shown in FIG. 9, the power conducting cable 51 may include only three magnets 67, 69 and 71, located in the exact same radial positions as illustrated in FIG. 2. Also, the jacket 65 may be made round, like the jacket 12 of FIG. 2. As such, the power conducting cable 51 may be substituted for any one or more of the cables A, B, C, D, E, F, G, H and I in FIGS. 3-6. Further, the magnets may abut the inner surface of the jacket 65, or may be attached to the outer surface of the jacket 65, as illustrated in FIGS. 7 and 8.

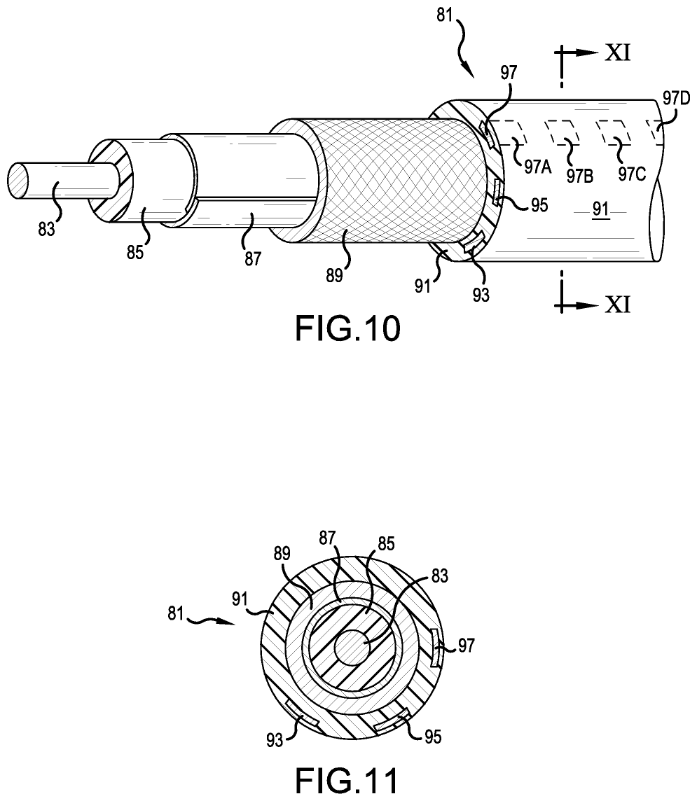

FIG. 10 is a front perspective view of a cable 81 in accordance with a third embodiment of the present invention. FIG. 11 is a cross sectional view taken along line XI-XI in FIG. 10. At least one communication carrying medium, such as a conductive medium, extends along a length of the cable 81. In the embodiment of the FIGS. 10 and 11, the at least one conductive medium includes a first conductive medium 83. A first dielectric layer 85 surrounds the first conductive medium 83 along the length of the cable 81. Second and third conductive mediums 87 and 89 surround the first dielectric layer 85 along the length of the cable 81. The second and third conductive mediums 87 and 89 may take the form of a foil and a woven metal mesh, respectively.

A jacket 91 surrounds the second and third conductive mediums 87 and 89, such that the cable 81 is a coaxial cable 81. The jacket 91 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art. Of particular relevance to the present invention, first, second and third magnets 93, 95 and 97 are embedded within the jacket 91. The first, second and third magnets 93, 95 and 97 may be formed as rare-earth magnets, such as an alloy of neodymium, iron and boron neodymium, e.g., neodymium magnets.

The first, second and third magnets 93, 95 and 97 may be embedded into the jacket 91 as the jacket 91 is being extruded onto the cable core. As the extruded jacket 91 is cooled in a water bath, the jacket 91 will solidify around the first, second and third magnets 93, 95 and 97 to capture the magnets within the material forming the jacket 91.

As with the first embodiment, the first, second and third magnets 93, 95 and 97 are spaced from each other in a radial direction, e.g., the same radial positioning as shown in FIG. 2. Each of the first, second and third magnets 93, 95 and 97 extends continuously along the length of the coaxial cable 81. Alternatively, each of the first, second and third magnets 93, 95 and 97 does not extend continuously, but rather is a series of shorter magnets, where the series extends along the length of the coaxial cable 81, like the dashed line segments 97A, 97B, 97C and 97D, illustrated in FIG. 10. The magnets will allow the coaxial cable 81 to be magnetically coupled to another coaxial cable 81, a power conducting cable 51 or to a twisted pair cable 11, either by direct jacket-to-jacket coupling, or via an intermediate spine.

As such, the coaxial cable 81 may be substituted for any one or more of the cables A, B, C, D, E, F, G, H and I in FIGS. 3-6. Further, the magnets abut the inner surface of the jacket 91, or may be attached to the outer surface of the jacket 91, as illustrated in FIGS. 7 and 8.

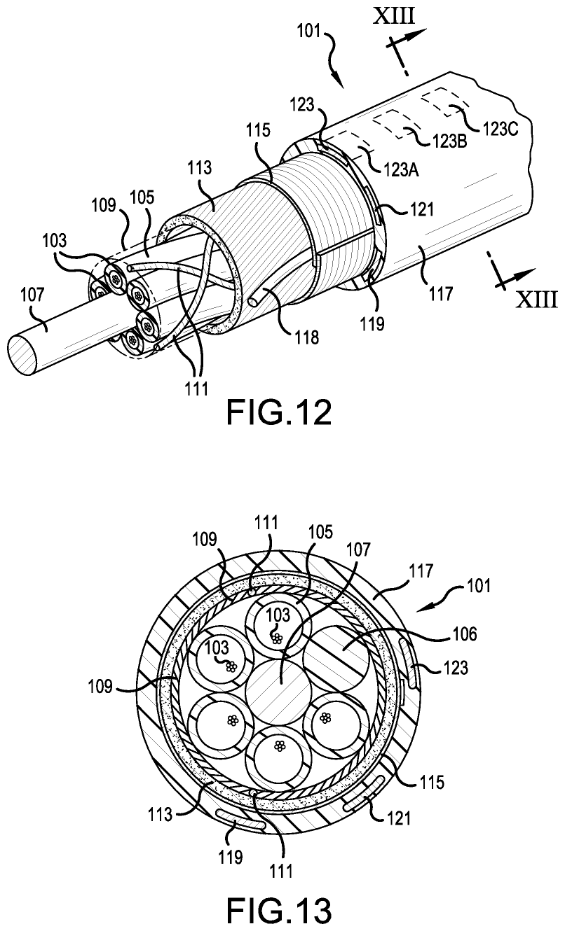

FIG. 12 is a front perspective view of a cable 101 in accordance with a fourth embodiment of the present invention. FIG. 13 is a cross sectional view taken along line XIII-XIII in FIG. 12. At least one communication medium extends along a length of the cable 101. In the embodiment of the FIGS. 12 and 13, the at least one communication medium includes at least one optical fiber 103.

For example, a plurality of buffer tubes 105 may each house a plurality of optical fibers 103. In FIGS. 12 and 13, each buffer tube 105 houses six optical fibers 103, however other numbers are also possible, like two, four, eight, or twelve optical fibers 103 per buffer tube 105. FIGS. 12 and 13 illustrate five buffer tubes 105 and a dielectric spacer 106, such that the cable includes thirty optical fibers 103. More than one dielectric spacers 106 may be added to the cable core, and the number of optical fibers 103 per buffer tube 105 may be changed, so that the total optical fiber count of the cable 101 can be modified. Also, a gel, such as a water blocking gel, may be added within the buffer tubes 105.

A central strength member 107 is located within the cable 101. The central strength member 107 may be formed as a glass reinforced plastic rod, i.e., a GRP rod. The GRP rod may add stability to the cable 101 in the form of rigidity and tensile strength. The buffer tubes 105, dielectric spacer 106 and central strength member 107 may be wrapped by a tape 109, such as a water-blocking tape 109. The water-blocking tape 109 is held onto the cable core by two or more binders 111, which may take the form of KEVLAR® threads or strips.

A plurality of flaccid strength elements 113 surrounds the binders 11 and the water-blocking tape 109. The flaccid strength elements 113 may be formed of aramid fibers, sold under the trademark KELVAR®. A shielding layer 115 surrounds the flaccid strength elements 113. In the illustrated embodiments of the present application, the shielding layer 115 is formed by laminated aluminum, such as MYLAR® coated onto an aluminum foil. However, other materials may be used to form the shielding layer 115. An optional drain wire 118 is also illustrated in FIG. 12.

A jacket 117 surrounds the shielding layer 115, such that the cable 101 is a fiber optic cable 101. The jacket 117 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art. Of particular relevance to the present invention, first, second and third magnets 119, 121 and 123 are embedded within the jacket 117. The first, second and third magnets 119, 121 and 123 may be formed as rare-earth magnets, such as an alloy of neodymium, iron and boron neodymium, e.g., neodymium magnets.

The first, second and third magnets 119, 121 and 123 may be embedded into the jacket 117 as the jacket 117 is being extruded onto the cable core. As the extruded jacket 117 is cooled in a water bath, the jacket 117 will solidify around the first, second and third magnets 119, 121 and 123 to capture the magnets within the material forming the jacket 117.

As with the first embodiment, the first, second and third magnets 119, 121 and 123 are spaced from each other in a radial direction, e.g., the same radial positioning as shown in FIG. 2. Each of the first, second and third magnets 119, 121 and 123 extends continuously along the length of the fiber optic cable 101. Alternatively, each of the first, second and third magnets 119, 121 and 123 does not extend continuously, but rather is a series of shorter magnets, where the series extends along the length of the fiber optic cable 101, like the dashed line segments 123A, 123B and 123C illustrated in FIG. 12. The magnets will allow the fiber optic cable 101 to be magnetically coupled to another fiber optic cable 101, a coaxial cable 81, a power conducting cable 51 or to a twisted pair cable 11, either by direct jacket-to-jacket coupling, or via an intermediate spine.

As such, the fiber optic cable 101 may be substituted for any one or more of the cables A, B, C, D, E, F, G, H and I in FIGS. 3-6. Further, the magnets may abut the inner surface of the jacket 117, or may be attached to the outer surface of the jacket 117, as illustrated in FIGS. 7 and 8.

A method of manufacturing the cables 11, 51, 81 and 101, wherein magnets are embedded within a wall of the jackets 12, 65, 91 and 117, as depicted in FIGS. 2 and 9-13 will now be described. The method includes providing an extruder and a die. Polymer pellets are added to the extruder. A conductive or communication carrying medium is fed to the die. The medium may be optical fibers within buffer tubes, twisted pairs of insulated wires, untwisted insulated wires, coaxial conductors, etc. The medium is typically fed from a reel or spool. The polymer pellets are melted and extruded to form a jacket over the medium using the die. As the jacket is being extruded, at least one magnet is position into the extruded jacket material, so as to embed the at least one magnet within the jacket.

A method of manufacturing the cables 11, 51, 81 and 101, wherein magnets are abutting, e.g., attached or not attached, with the inside wall 10 of the jackets 12, 65, 91 and 117, as depicted in FIG. 7 will now be described. The method includes providing an extruder and a die. Polymer pellets are added to the extruder. A conductive or communication carrying medium is fed to the die. At least one magnet is also fed to the die. The at least one magnet may be fed from a reel or spool, much like a drain wire or a ripcord. The polymer pellets are melted and extruded to form a jacket over the medium and the at least one magnet using the die. Just as ripcords and drain wires are typically adjacent to the inner surface 10 of the jacket 12, the at one magnets will be finally positioned adjacent to the inner surface 10 of the jacket 12, as depicted in FIG. 7.

A method of manufacturing the cables 11, 51, 81 and 101, wherein magnets are attached to the outside wall 8 of the jackets 12, 65, 91 and 117, as depicted in FIG. 8 will now be described. The method includes providing an extruder and a die. Polymer pellets are added to the extruder. A conductive or communication carrying medium is fed to the die. The polymer pellets are melted and extruded to form a jacket over the medium using the die. After the jacket is cooled, the magnets may be applied to the outer surface 8 of the jacket, as depicted in FIG. 8. The application may take place proximate the production stage where the jacket passes through labeling machines, which print or etch data onto the outer surface 8 of the jacket relating to length markers, production date, manufacturer, part number, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A cable comprising:
a conductive medium extending along a length of said cable;
a jacket surrounding said conductive medium along the length of said cable; and
a magnet embedded within, attached to an outer surface of, or abutting an inner surface of, said jacket.

2. The cable according to claim 1, wherein said conductive medium is a first conductive medium, and further comprising:
a first insulation layer surrounding said first conductive medium to form a first insulated wire;
a second conductive medium extending along the length of said cable; and
a second insulation layer surrounding said second conductive medium to form a second insulated wire, wherein said jacket surrounds said first and second insulated wires.

3. The cable according to claim 2, wherein said first and second insulated wires are twisted about each other to form a first twisted pair extending along the length of said cable, and further comprising:
second, third and fourth twisted pairs extending along the length of said cable within said jacket to form a twisted pair cable.

4. The cable according to claim 2, further comprising:
a third conductive medium extending along the length of said cable, wherein said jacket surrounds said first and second insulated wires and said third conductive medium to form a power cable.

5. The cable according to claim 2, further comprising:
a third conductive medium extending along the length of said cable; and
a third insulation layer surrounding said third conductive medium to form a third insulated wire, wherein said jacket surrounds said first, second and third insulated wires to form a power cable.

6. The cable according to claim 1, wherein said conductive medium is a first conductive medium, and further comprising:
a first dielectric layer surrounding said first conductive medium along the length of said cable; and
a second conductive medium surrounding said first dielectric layer along the length of said cable, wherein said jacket surrounds said second conductive layer to form a coaxial cable.

7. The cable according to claim 1, wherein said magnet is a first magnet and further comprising:
a second magnet embedded within, attached to an outer surface of, or abutting an inner surface of, said jacket, wherein said first magnet is located in a first position along said jacket and said second magnet is located in a second position along said jacket.

8. The cable according to claim 7, wherein said second position is spaced from said first position along the length of said cable, and further comprising:
plural additional magnets spaced along the length of said cable so as to form, in conjunction with said first and second magnets, a series of spaced magnets extending linearly along the length of said cable.

9. The cable according to claim 7, wherein said second position is spaced from said first position radial around a perimeter said jacket.

10. The cable according to claim 9, wherein said second position is located less than ninety degrees away from said first position around the perimeter of said jacket.

11. The cable according to claim 9, wherein said first magnet extends continuously along the length of said cable, and said second magnet extends continuously along the length of said cable.

12. A cable comprising:
a communication carrying medium extending along a length of said cable;
a jacket surrounding said communication carrying medium along the length of said cable; and
a magnet embedded within, attached to an outer surface of, or abutting an inner surface of, said jacket.

13. The cable according to claim 12, wherein said communication carrying medium includes at least one optical fiber.

14. The cable according to claim 12, wherein said communication carrying medium includes a plurality of optical fibers, and further comprising:
a buffer tube surrounding said plurality of optical fibers;
a central strength member; and
a plurality of flaccid strength elements, wherein said jacket surrounds said buffer tube, said central strength member and said plurality of flaccid strength elements.

15. The cable according to claim 12, wherein said communication carrying medium includes at least one twisted pair of insulated conductors.

16. The cable according to claim 12, wherein said magnet is a first magnet and further comprising:
a second magnet embedded within, attached to an outer surface of, or abutting an inner surface of, said jacket, wherein said first magnet is located in a first position along said jacket and said second magnet is located in a second position along said jacket.

17. The cable according to claim 16, wherein said second position is spaced from said first position along the length of said cable, and further comprising:
plural additional magnets spaced along the length of said cable so as to form, in conjunction with said first and second magnets, a series of spaced magnets extending linearly along the length of said cable.

18. The cable according to claim 16, wherein said second position is spaced from said first position radial around a perimeter said jacket.

19. A method of forming a cable comprising:
providing an extruder and a die;
adding polymer pellets to the extruder;
feeding a conductive or communication carrying medium to the die; and wherein the method further comprises at least one of A, B or C:
where (A) includes melting the polymer pellets; extruding the melted polymer pellets to form a jacket over the medium using the die; and positioning at least one magnet into the extruded jacket, so as to embed the at least one magnet within the jacket;
where (B) includes feeding at least one magnet to the die; melting the polymer pellets; and extruding the melted polymer pellets to form a jacket over the medium and the at least one magnet using the die; and
where (C) includes melting the polymer pellets; extruding the melted polymer pellets to form a jacket over the medium using the die; and attaching at least one magnet onto an outer surface of the jacket.

20. The method according claim 19, wherein the method further comprises:
melting the polymer pellets;
extruding the melted polymer pellets to form a jacket over the medium using the die; and
positioning at least one magnet into the extruded jacket, so as to embed the at least one magnet within the jacket.
